(19) United States
(12) Patent Application Publication
(10) Pub. No.: US 2022/0160558 A1
(43) Pub. Date: May 26, 2022

(54) BED TOILET SYSTEM

(71) Applicant: Cusack GORDON, Solihull, West Midlands (GB)

(72) Inventor: Cusack GORDON, Solihull, West Midlands (GB)

(21) Appl. No.: 17/430,900

(22) PCT Filed: Feb. 13, 2020
(86) PCT No.: PCT/EP2020/053811

§ 371 Date: Aug. 13, 2021

(30) Foreign Application Priority Data
Feb. 20, 2019 (GB) 1902288.8

(51) Int. Cl. A61G 7/02

(52) U.S. Cl. CPC A61G 7/02

(57) ABSTRACT

A mobile toilet system including: a head and a body, the proximal end of the body adapted for engagement with the ground and the distal end adapted for support of the head, the head extending laterally from first to second ends, and connected to the distal end of the body, the head having upper and lower surfaces, the upper surface having a seat bedpan assembly, wherein the lower surface is inclined to the lateral direction to taper with a narrowing second from the second end to the first end, wherein the head is movable in the lateral direction between disengaged and engaged positions with the lower surface maintained with the incline to the lateral direction, wherein in the engaged position a seat is arrangeable over a support surface of a patient support and in the disengaged position the head is arrangeable distal the patient support, the system having a reservoir.

### TECHNICAL FIELD

The present disclosure relates to the field of toilet systems. In particular, the disclosure relates to a toilet system for use with a bed such as a hospital bed.

### BACKGROUND

A toilet system may be implemented in hospitals for patients who are disabled by illness or by injury, such that they are generally confined to a hospital bed. Accordingly, the toilet system is indented for use in combination with the hospital bed.

FIGS. 10 to 14 of U.S. Pat. No. 4,989,280 A disclose an example toilet system wherein a wedge-shaped bedpan unit is elevated into alignment with a hospital bed, extended laterally across an exterior surface of a mattress of said bed, and inserted between the patient and mattress. Air sacks present in the mattress are arranged in a deflated state to provide a channel along which the bedpan is inserted. The wedge-shape comprises an angled patient facing surface, which facilitates said insertion. Subsequent to insertion, the bedpan is reoriented by inflation of the air sacks present in the mattress so that said patient facing surface is generally parallel to the lateral direction of the mattress. Then, in this position, the patient interfaces with the bedpan.

A drawback with this implementation is that a complex series of actuations and air sack operations are required to manoeuvre the bedpan in and out of position. Moreover, the mattress requires specific adaptation for use with the bedpan.

Moreover, a storage container stores waste material from a user. The storage container has to be removed, emptied and cleaned to dispose of the waste material.

Therefore, in spite of the effort already invested in the development of toilet systems further improvements are desirable.

### SUMMARY

The present disclosure provides a mobile toilet system comprising a head and a body, the head including a seat bedpan assembly. The body extends longitudinally from a proximal end to a distal end, the proximal end adapted for engagement with the ground (e.g. it comprises a surface suitable to abut the ground and provide a stable support for said system) and the distal end adapted for support of said head. The head extends laterally from a first end to a second end, and is connected to the distal end of the body. The first end includes the seat bedpan assembly. The head comprises an upper surface and a lower surface. The upper surface comprises a seat of the seat bedpan assembly.

In embodiments, the lower surface is inclined to the lateral direction to taper with a narrowing section from the second end to the fist end. In embodiments, the head is movable in the lateral direction between a disengaged position and an engaged position with said lower surface maintained with said incline to the lateral direction. In the engaged position, the seat of the bed pan assembly is arrangable over a support surface of a patient support and in the disengaged position the seat of the bedpan assembly is arrangable distal the patient support.

By enabling the head to move from the engaged to disengaged position while maintaining the inclined lower surface in the same orientation relative to the ground, the mobile toilet system can be more conveniently coupled with the patient support than for prior art systems. Particularly, it does not require the patient support to be specifically adapted for operation therewith, nor are there multiple steps of reorientation for the head.

Moreover, the inclining of the lower surface permits progressive compression in a depth direction of the patient support whilst moving to the engaged position, which can enhance stability. For example, load of a patient using the system is transmitted through both the system and compressed patient support. The narrowing taper may also allow the first end to be shallower than prior art systems, thereby providing a more comfortable system since the bedpan seat may be positioned closer to the support surface when in use. Such a configuration may permit a more cost effective and/or lightweight system than in the prior art.

Moreover, the inclining of the lower surface permits the system to interface with patient supports of varying height without readjustment of the height of the head. The system may be used with a variety of patient supports, without requiring the patient support to be specifically adapted (e.g. by requiring a cut-out section in a mattress).

In embodiments, the mobile toilet system comprises a reservoir fluidly connected to the bedpan assembly, an outlet of the reservoir arranged at a second end of the head at a base thereof, or in operative proximity thereto. By implementing an outlet at the lower surface of the second end (or in operative proximity thereto, e.g. on a proximal side wall), waste material may be conveniently stored in the reservoir and dispensed via the outlet via gravity without the need for an ejection system. In embodiments also having an inclined lower surface, the waste disposal may be even more efficient, since the incline can help support the transmission of the waste material under gravity to the reservoir and/or outlet.

In embodiments, the head is movable in the lateral direction between the disengaged position and the engaged positions with the upper surface maintained aligned to the lateral direction. By configuring the upper surface as maintained in the same position with respect to the lateral plane when moved between the engaged and disengaged positions, the mobile toilet system can more conveniently interface with the patient than for prior art systems, e.g. a step of reorientation of the upper surface is obviated. Moreover, any waste material is less likely to escape since the upper surface can be retracted from the engaged position to the disengaged position without reorientation.

In embodiments, an angle of inclination between the upper surface and lower surface is 10° to 30°. Said angle may support effective progressive compression of the patient support surface as the head is moved from the disengaged to the engaged position.

In embodiments, to move the head between the disengaged position and the engaged position, the proximal end of the body is adapted to slide along the ground. In embodiments, the proximal end of the body comprises wheels and an optional drive system. In embodiments, the wheels are configured to permit motion backwards and forwards in only one direction.

In embodiments, to move the head between the disengaged position and the engaged position, the head is slideably connected to the body. Said slideable connection may enable convenient actuation of the head once the body is located in the desired position with respect to the patient support.

In embodiments, the head and/or body are adapted for user actuation between the disengaged position and the engaged position. Said adaptation may comprise handles arranged at the first and/or second end. Implementation of a user actuated system may permit a cost effective mobile toilet system.

In embodiments, the head is mechanically actuated between the disengaged position and the engaged position by an automated drive system. A mechanically actuated system may permit a more convenient to use mobile toilet system.

In embodiments, the mobile toilet system includes a patient support position detection system operable to determine a position of the patient support and enable the automated drive system to drive the head between the disengaged position and the engaged position based on the determined position of the patient support. By implementing the patient support position detection system and the automated drive system to drive the head to an engaged position based on the determined position of the patient support, it can be ensured that the head is arranged in an extended position to suitably engage the patient support surface, e.g. it is sufficiently extended over the patient support surface to provide access to the user and/or for stability. Moreover, the position adjustment may be automatic, thus making the system convenient to use.

In embodiments, the mobile toilet system includes electrical circuitry to store a user preference and to control the automated drive system to drive the head between the disengaged position and an engaged position based on the user preference. With such an implementation a user may selectively configure the mobile toilet system to provide the desired extension over the patient support surface.

In embodiments, the head is slideably connected to the body to slide along the longitudinal axis to adjust a height of the head. With a slideable connection a user is able to adjust the height of the head to suit a height of the patient support surface. In embodiments, the mobile toilet system includes a patient support position detection system operable to determine a position of the patient support, and an automated drive system to drive the head to a height based on the determined position of the patient support. By implementing the patient support position detection system and the automated drive system to drive a height of the head to a position based on the determined position of the patient support, it can be ensured that the head is arranged at a height to suitably engage the patient support surface, e.g. to enable the head to be sufficiently extended over the patient support surface. Moreover, the height adjustment may be automatic, thus making the system convenient to use.

In embodiments, the mobile toilet system includes electrical circuitry to store a user preference and controls the automated drive system to drive the head to a height based on the determined position of the patient support. With such an implementation a user may selectively configure the mobile toilet system to provide the desired height for the patient support surface.

In embodiments, the mobile toilet system of the proximal end of the body comprises a docking member adapted to engage with a conventional toilet, the docking member arranged to locate said conventional toilet for receiving fluid from the reservoir via the outlet. By implementing a docking member, it can be ensured that the outlet of a docked mobile toilet system is arranged to transmit waste material directly into the conventional toilet for appropriate disposal.

In embodiments, the docking member comprises an adjustable channel for engagement with the conventional toilet. For example, the docking member may be configured to be adjustable in the sense of adjustably varying the width of the channel for engagement with the toilet. An adjustable docking member may be easily engaged with a plurality of conventional toilets having different sizes and/or shapes.

In embodiments, the second end of the head comprises a generally planar base, which is aligned to the upper surface. Said base may aid in docking with a conventional toilet, for example, it may abut a rim of the toilet bowl to ensure the toilet is docked in a suitable position.

In embodiments, the lower surface tapers with a nonlinear profile, such as a concave profile. The nonlinear profile may help to progressively compress the patient support when moving the head from the disengaged position to the engaged position. Furthermore, the first end of the head may be significantly narrower in embodiments having a concave profile compared to a straight or convex profile. This may allow the seat to be positioned closer to the support surface, making the system more comfortable to use.

In embodiments, the system includes a handle that is rotatable about the head. A rotatable handle may facilitate manual relocation of the system, by allowing a carer to push the system from either side thereof. The handle may also be held by a user to provide further stability while the bedpan is in use.

In embodiments, the system further includes a retaining member to maintain the handle in a position with respect to the head. The retaining member may provide further stability to the handle, thereby further helping a carer to manoeuvre the system.

Also provided is a splash guard to removably couple to a bedpan. A detachable splash guard may facilitate easy positioning under a user, and may facilitate cleaning. In embodiments, the splash guard includes a groove for guiding a catheter toward the bedpan.

The present disclosure provides a method of engaging a mobile toilet system with a patient support surface of a patient support. The method may comprise moving a first end of a head of the toilet system over said patient support surface, wherein a lower surface of the head arranged proximal the patient support surface tapers from a second end of the head to the first end to effect progressive compression of the patient support. The method may implement any step disclosed in the preceding embodiments, or other embodiments disclosed herein.

In embodiments, the method further comprises: moving the second end of the head over a conventional toilet; and dispensing waste through an outlet arranged at the second end of the head into the conventional toilet.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description, Figures, and Claims.

### BRIEF DESCRIPTION OF THE FIGURES

Aspects, features and advantages of embodiments of the present disclosure will become apparent from the following description of embodiments in reference to the appended drawings in which like numerals denote like elements.

FIG. 1 is a perspective view showing an embodiment mobile toilet system.

FIG. 2 is a side view showing the mobile toilet system of FIG. 1.

FIGS. 3 and 4 are perspective views showing the mobile toilet system of FIG. 1 engaged with a patient support.

FIGS. 5 and 6 are respective side and perspective views showing the mobile toilet system of FIG. 1 engaged with a conventional toilet.

FIG. 7 is a side cross-sectional view showing the mobile toilet system of FIG. 1.

FIG. 8 is a perspective view showing another embodiment mobile toilet system.

FIGS. 9 and 10 are perspective views showing the mobile toilet system of FIG. 8 engaged with a patient support.

FIG. 11 is a perspective view showing the mobile toilet system of FIG. 8 engaged with a conventional toilet.

FIG. 12 is a plan view showing a control panel of the mobile toilet system of FIG. 8.

FIG. 13 is a perspective view showing the seat bedpan assembly of the system of FIG. 8.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “mobile toilet system” or “system” may refer to a toilet which is portable, i.e. it is able to move between different locations to support users at said locations.

As used herein, the term “conventional toilet” may refer to a toilet with a bowl to interface with a user (e.g. by sitting) arranged on a wall or ground support. The toilet is arranged for collection and disposal of waste material as defined herein.

As used herein, the term “waste material” may refer to any material expelled from a body of a user.

As used herein, the term “patient support” may refer to a bed, stretcher, or other like support for a user in a generally horizontal position. The patient support may be compressed by the mobile toilet system when in the engaged position.

As used herein, the term “user” may refer to a patient or other person using the patient support.

As used herein, the term “inclined” may refer to a surface being non-parallel to a reference line. The incline may be constant along the surface (i.e. to provide a surface with a straight profile) or may vary along the surface (e.g. to provide a surface with a curved or stepped profile).

As used herein, “camera” or “camera system” may refer to a system comprising one or more cameras operable to capture images in a suitable band (including visible, infra-red or UV) for detecting a position of the patient support. A camera may include any suitable image sensor for capturing emissions, e.g. a photodiode and other semiconductor systems.

As used herein, the term “electrical circuitry” or “electric circuitry” or “circuitry” or “control circuitry” may refer to, be part of, or include one or more of the following or other suitable hardware or software components: an Application Specific Integrated Circuit (ASIC); electronic/electrical circuit (e.g. passive components, which may include combinations of transistors, transformers, resistors, capacitors); a processor (shared, dedicated, or group); a memory (shared, dedicated, or group), that may execute one or more software or firmware programs; a combinational logic circuit. The electrical circuitry may be centralised on the apparatus or distributed, including distributed on board the apparatus and/or on one or more components in communication with the apparatus, e.g. as part of the system. The component may include one or more of a: networked-based computer (e.g. a remote server); cloud-based computer; peripheral device. The circuitry may be implemented in, or functions associated with the circuitry may be implemented by, one or more software or firmware modules. The circuitry may include logic, at least partially operable in hardware.

As used herein, the term “processor” or “processing resource” may refer to one or more units for processing including as an ASIC, microcontroller, FPGA, microprocessor, digital signal processor (DSP) capability, state machine or other suitable component. A processor may include a computer program, as machine readable instructions stored on a memory and/or programmable logic. The processor may have various arrangements corresponding to those discussed for the circuitry, e.g. on-board and/or off board the apparatus as part of the system.

As used herein, the term “user interface” may refer to any device or plurality of devices capable of interfacing a user with the electrical circuitry. User interface may include: buttons; switches keys; other user actuatable elements, including those as part of a graphical display.

### First Embodiment

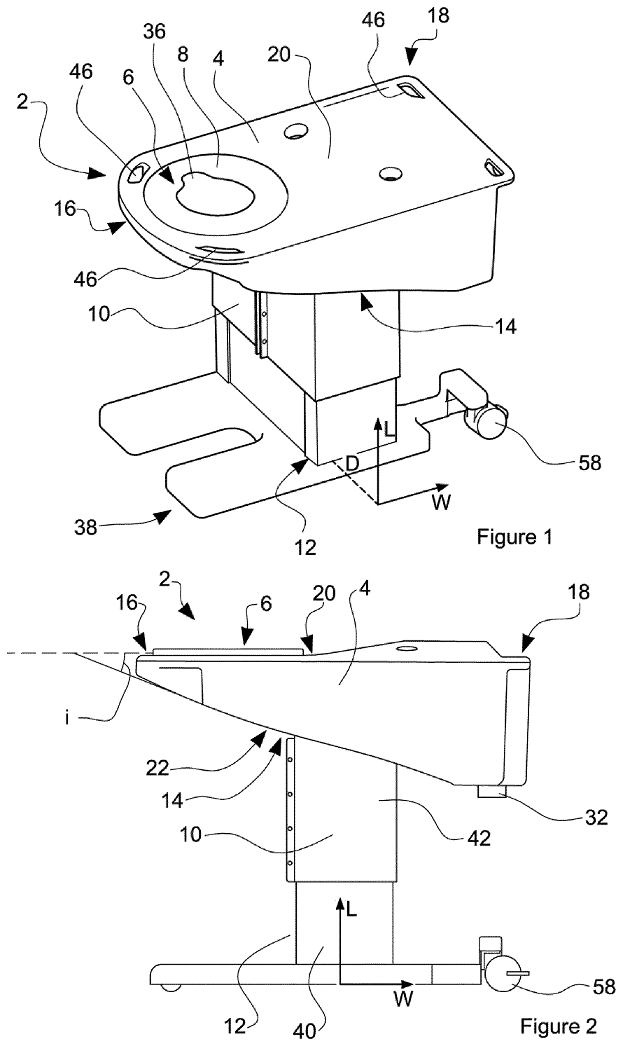

Referring to FIGS. 1 to 4, an embodiment mobile toilet system 2 comprises a head 4, a waste material capturing system 6, and a body 10.

The body 10 extends in a longitudinal direction L from a proximal end 12 to a distal end 14, wherein proximal is defined relative the ground G upon which the toilet system sits. The proximal end 12 is adapted for engagement with the ground. The distal end 14 is adapted for support of the head 4.

The head 4 extends in a lateral direction W from a first end 16 to a second end 18. The head 4 is connected to the distal end 14 of the body 10, and is movable relative to the body 10. The first end 16 includes a seat bedpan assembly 8 of the waste material capturing system 6. The head 4 includes an upper surface 20 and a lower surface 22, the upper surface 20 comprising the seat bedpan assembly 8. The lower surface 22 is inclined at angle i to the lateral direction W, such that it tapers with a narrowing section from the second end 18 to the first end 16. As used herein the term “taper” may refer to a linear or nonlinear change in section thickness between the upper surface 20 and lower surface 22, it may include piecewise linear and other local steps or other variations within an overall narrowing thickness. Accordingly, the “first end” may also be referred to as a “narrow end” or “shallow end”, and the “second end” may also be referred to as a “thick end” or “deep end.”

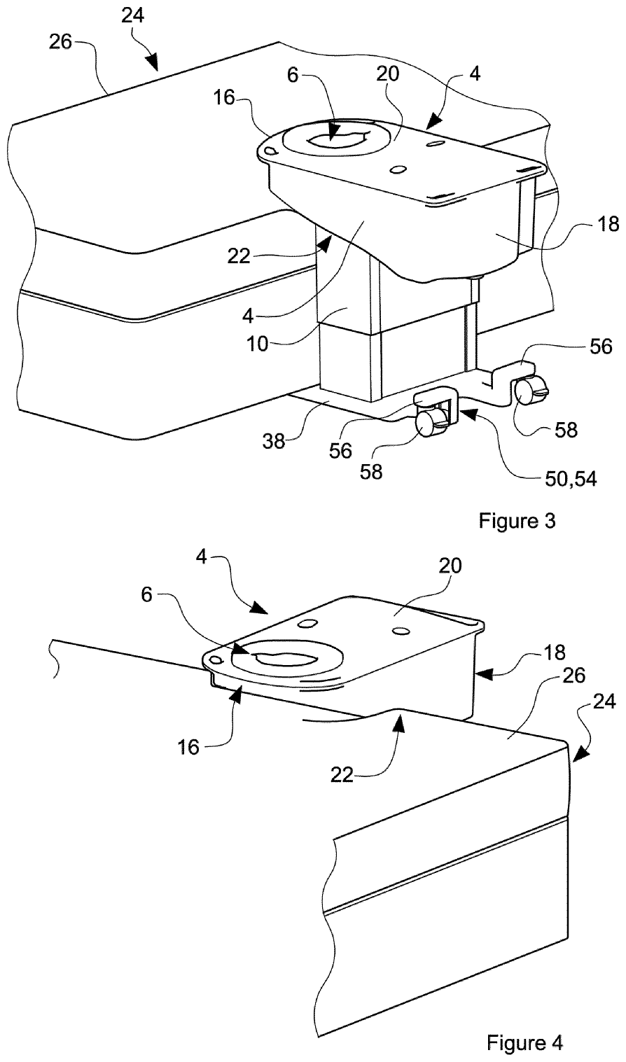

The head 4 is movable in lateral direction W, relative a patient support 24, between a disengaged position (FIGS. 1 and 2) and an engaged position (FIGS. 3 and 4) with said incline to the lateral direction W. In the engaged position the bed pan assembly 8 is arranged over a support surface 26 of a patient support 24 and in the disengaged position the head is arranged distal the patient support 24. Moreover, in the engaged position, lower surface 22 engages the support surface 26 to stabilise the system 2.

In particular, the head 4 is movable in the lateral direction W between the disengaged position and the engaged position with the lower surface 22 maintained with said incline, which aids progressive engagement of the support surface 26 for enhanced stability.

As used herein the term “progressive engagement” may refer to the lower surface 22 engaging the patient support 24 both in the lateral direction W and the longitudinal direction L, whereby as the lower surface 22 is moved laterally, its wedge configuration acts to progressively compress the patient support 24. Said compression may enhance the stability of the system 2. In particular, load from the patient on the system 2 can be distributed by the system 2 and also the patient support 24.

As can be seen when comparing FIGS. 1-2 with FIGS. 3-4, the head 4 is movable in the lateral direction W between the respective disengaged position and the engaged positions with the upper surface 20 maintained aligned to the lateral direction.

Referring to FIG. 7, the waste material capturing system 6 comprises the seat bed ban assembly 8, a reservoir 30 inside the head 4 and fluidly connected to the bedpan assembly 8, and an outlet 32 arranged at the second end 18 of the head 4 and fluidly connected to the reservoir 30. The reservoir 30 is configured to receive and store waste material from the pan 36 for later disposal through the outlet 32. Accordingly, the second end may also be referred to as a “drain end”, while the first end may also be referred to as a “seat end”.

The seat bed pan assembly 8 includes a seat 34 arranged as a user posterior support and a pan 36 (shown in FIG. 1) coupled to the seat 34 and arranged to capture waste material from the user whilst engaged with the seat 34. The reservoir 30 is formed as a removable unit (not shown) configured for extraction from the head 4 for periodic cleaning. In variant embodiments, which are not illustrated, the reservoir is formed integrally by the walls forming the head.

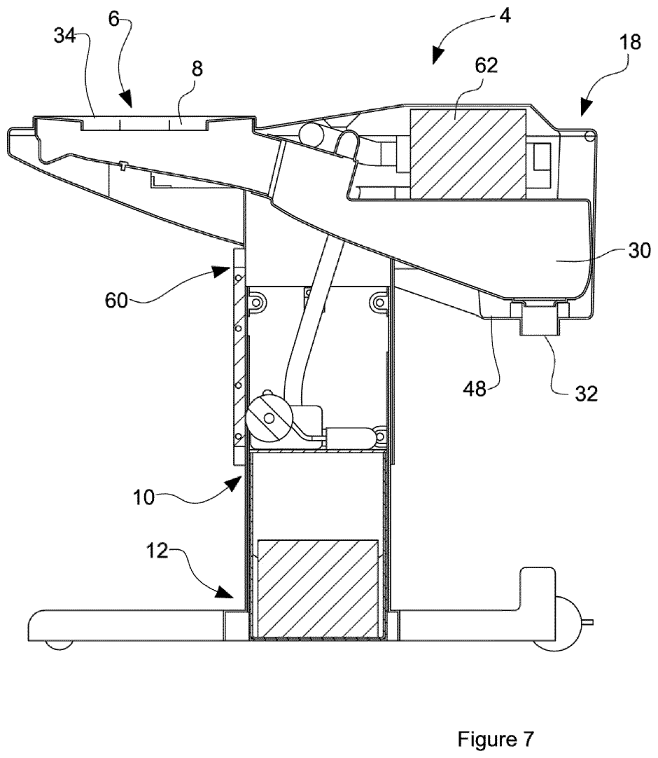

The outlet 32 is configured to release waste material from the toilet system 2. The outlet 32 is arranged at a lowest point on the head 4, which is referred to herein as the base 48, as will be discussed. The head 4 is offset from the body 10 to provide an overhanging second end 18 positionable at a height above a conventional toilet bowl (e.g. 35 cm above the ground). The outlet 32 is provided on this overhanging portion. Consequently, as shown in FIG. 6, the outlet 32 may drain directly into the conventional toilet bowl without the need for additional pipes.

As used herein, the term “overhanging” with respect to the head 4 refers to a portion of the head 4 that extends laterally beyond a foot 38 of the system. In this manner, the overhang may be positioned directly above a disposal location (e.g. directly above a conventional toilet bowl), while the foot 38 is positioned on the ground proximal the disposal location.

In variant embodiments, which are not illustrated, the outlet may be arranged in operative proximity to the base, depending on the particular configuration of the head. As used herein the term “operative proximity” may refer to any position proximal to the base, at the second end to achieve the function of transmission of the waste material from the reservoir via gravity, it may include on the adjoining lower surface, on an adjoining proximal side, or on an end surface (e.g. a vertical wall) in operative proximity to the base.

The outlet 32 includes a valve which is user actuatable, e.g. by an actuation mechanism (not shown). The actuation mechanism may comprise an actuatable element, which is actuatable to move the valve between an open and closed position.

In variant embodiments, the valve is automatically actuated on docking with a conventional toilet, e.g. by an actuation mechanism, which may comprise an actuatable element, which is actuatable on docking via abutment with the conventional toilet to move the valve between an open and closed position.

By implementing an outlet at the base (or in operative proximity thereto), waste material may be conveniently stored in the reservoir and dispensed via the outlet via gravity thus obviating the need for a dedicated ejection system.

The waste material capturing system may include a macerator pump (not shown) to dispose of solid waste, e.g. arranged between the fluidic coupling between the pan 36 and reservoir 30 or between the reservoir 30 and outlet 32.

The waste material capturing system 6 may include a flushing system 60 arranged to dispense fluid, such as water, into the pan 36 to aid in transmission of waste material to the reservoir 30. The flushing system 60 includes a pumping system and reservoir 62. The pumping system is arranged to pump fluid from the reservoir 62 to the pan 36. The reservoir 62 is arranged at the proximal end 12 of the body 10. The weight of the fluid (typically water) arranged in the proximal end 12 of the body 10 may stabilise the system 2. In variant embodiments, which are not illustrated, the reservoir 62 is alternatively arranged, e.g. in the head 4.

The head 4 comprises said upper surface 20 and lower surface 22 and interconnecting side and end walls to form a cavity for housing the waste material capturing system 6. Due to the aforementioned tapering of the lower surface 22, the second end 18 extends to a lower depth than the first end 16. Hence the tapering supports the combinatory effects of the previously described progressive compression of the patient support and transmission of the waste material under gravity to the outlet 32.

The waste material capturing system 6 may include a cleansing system (not shown), which is arranged to project fluid from the reservoir 62 and from the pan 36 to the user to cleanse the user.

The angle i of inclination between the upper surface 20 and lower surface 22 may be set to between 10° and 30° or more preferably between 15° and 25°. The head 4 may have a depth of 5 centimetres at the first end 16 and may have a depth of 10 centimetres at the second end 18.

The body 10 comprises a vertical column arranged to suspend the head 4 at the correct height for interfacing with the patient support 24. The proximal end 12 comprises a foot 38 which extends laterally in the direction of the first 16 and second 18 ends of the head 4 to provide a stable structural support. In particular, the foot 38 may be adapted (e.g. by one or more low profile elongate members that extend in the lateral W direction) to slide under the patient support 24 to enhance stability. A plurality of elongate members (as illustrated) may enable the members to be more conveniently inserted, e.g. a foot or leg of the patient support surface can be arranged between said members rather than block insertion.

The distance between the proximal end 12 and distal end 14 of the body is adjustable so that the head 4 may correctly interface with patient supports 24 of varying heights. In particular, the body 10 comprises a first portion 40 associated with the proximal end 12 and a second portion 42 associated with the distal end 14. The first portion 40 and second portion 42 are slideably connected to provide said height adjustment. The slideable connection may be implemented in any suitable way, e.g.: telescopic; cooperating channels; rack and pinion; hydraulic ram.

A drive system (not shown) may be implemented to drive the slideable connection to provide the desired height. The drive system may comprise an electrical motor, hydraulic or other suitable implementation.

In embodiments, the mobile toilet system 2 includes a patient support 24 position detection system operable to determine a position of the patient support 24, e.g. the height and/or lateral position. The position detection system may be implemented as a camera system with image recognition and processing, via feature extraction or other suitable proximity sensing system.

The mobile toilet system 2 may implement electrical circuitry (not shown) to obtain a height of the patient support 24 via the position detection system and to control the drive system to drive the height of the head 4 to a height suitable to interface with the patient support 24. Said high adjustment may be implemented as automatic when the patient support surface 26 is detected in proximity of the position detection system.

In embodiments, the mobile toilet system 2 includes the electrical circuitry to store a user preference height and controls the automated drive system to drive the head 4 to said height. The electrical circuitry may store the user preference height in a memory. The height may be stored and set via a user interface (not shown). In embodiments, a height of the head is adjustable by the user interface, e.g. via selection of a toggle up/down selection button.

In variant embodiments, which are not illustrated, the height of the head 4 is fixed, i.e. the body has no height adjustment.

The head 4 is slideably connected to the body 10 to enable the head 4 to move relative the body 10 between the disengaged position and the engaged position. The slideable connection may be implemented in any suitable way, e.g.: telescopic; cooperating channels; rack and pinion; hydraulic ram.

In embodiments, the slideable connection is actuated by a user. The head 4 may include handles 46 adapted for said actuation. Said handles 46 may be arranged at the first 16 and/or second end 18.

In embodiments, a further drive system (not shown) is implemented to drive the slideable connection to provide the desired lateral extension of the head 4 in the engaged position. The drive system may comprise an electrical motor, hydraulic or other suitable implementation.

The mobile toilet system 2 may implement electrical circuitry (not shown) to obtain a lateral position of the patient support 24 via the position detection system and to control the drive system to drive the lateral position of the head 4 to a position where is it suitably extended over the patient support surface and is accessible by a user arranged thereon. Said lateral adjustment may be implemented as automatic when the patient support surface is detected in proximity of the position detection system.

In embodiments, the mobile toilet system 2 includes the electrical circuitry to store a user preference lateral position and controls the automated drive system to drive the head 4 to said position. The electrical circuitry may store the user preference lateral position in a memory. The lateral position may be stored and set via a user interface (not shown). In embodiments, a lateral position is adjustable by the user interface, e.g. via selection of a toggle left/right selection button.

In variant embodiments, which are not illustrated, the head is fixed to the body. In such an embodiment, to move the head between the disengaged position and the engaged position, the proximal end of the body is adapted to slide along the ground, e.g. by means of wheels 58.

Referring to FIG. 3, the foot 38 of the body 10 includes a docking member 50 adapted to interlock with a conventional toilet 52, the docking member 50 arranged to locate said conventional toilet for receiving fluid from the reservoir via the outlet 32. As used herein, the term “interlock” refers to any means for engaging the mobile toilet system with the conventional toilet, and is not limited to an arrangement in which the system and conventional toilet reciprocally fasten onto each other.

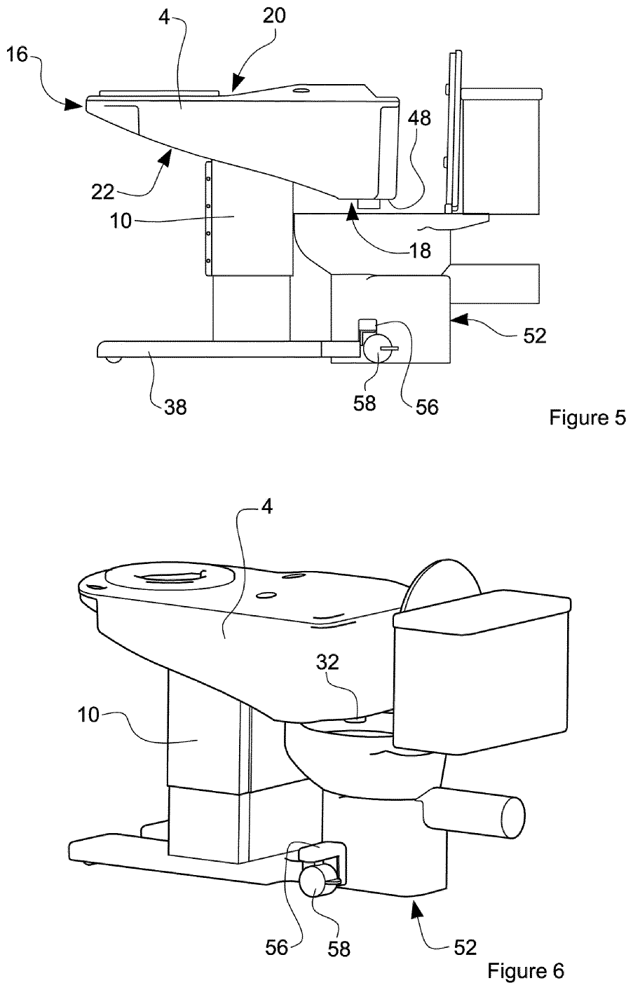

The docking member 50 includes a channel 54 within which the conventional toilet may sit (as shown in FIGS. 5 and 6). The peripheries of the channel 54 comprise extensions 56 for supporting wheels 58. In this manner, the wheels 58 are located far apart and at the rearmost portion of the foot 38, which may enhance stability. In variant embodiments, which are not illustrated, the docking member is adjustable to vary the size (e.g. the width) and/or shape of the channel, e.g. by the extensions being movable towards/away from each other.

The wheels 58 are mounted to the extensions 56 about fixed axles (or via other suitable means) aligned in the depth direction D (see FIG. 1). With such a configuration, the toilet system 2 can slide precisely back and forth in the W direction when engaging with a patient support surface 26. In variant embodiments, which are not illustrated, the wheels are alternatively mounted, e.g. the rotational axis of the wheel may be rotatable in a plane aligned to the ground, such that the toilet system 2 can be manoeuvred in directions in addition to the W direction. In embodiments, the wheels comprise a locking system, e.g. a friction brake, to lock toilet system 2 in a position with respect to the ground, e.g. when in use by a patient for enhanced stability.

The electrical circuitry includes a power source, e.g. a rechargeable battery. In variant embodiments, which are not illustrated, the system does not include a battery, e.g. the system may be mains-powered.

In embodiments, the system includes remotely controllable electrical circuitry and a drive system to move the system to the engagement position. With such a configuration, a user positioned on the patient support may use the toilet system even without assistance from a carer. In embodiments, the electrical circuitry is further configured to disconnect the rechargeable battery from a mains power supply before effecting movement of the toilet system towards the patient support. The drive system may comprise an electrical motor, hydraulic or other suitable implementation.

Referring to FIG. 5, the second end 18 of the head 4 comprises a generally planar base 48, which is aligned to the upper surface 20 and adjoins the lower surface 22. Said base 48 abuts a rim of the toilet bowl of the conventional toilet 52 when docked.

In variant embodiments, which are not illustrated, the planar base may be omitted, e.g. the tapered lower surface extends to the end wall of the second end. In embodiments, the docking member is omitted, e.g. the system is configured to empty into devices other than a conventional toilet. In embodiments, the tapered lower surface is omitted, e.g. the upper and lower surface are aligned to each other.

### Second Embodiment

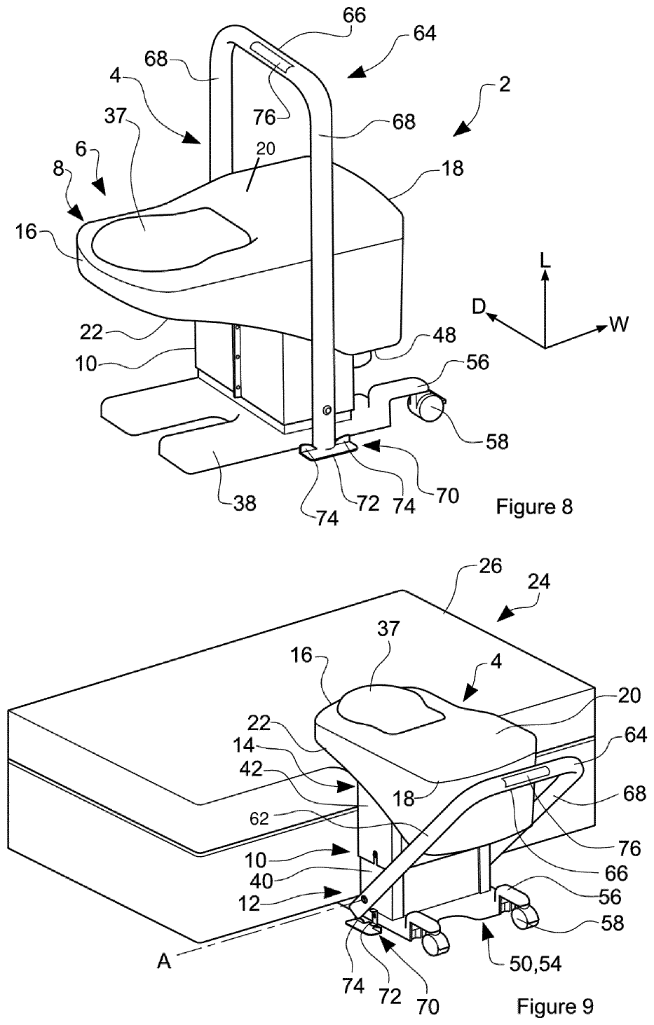

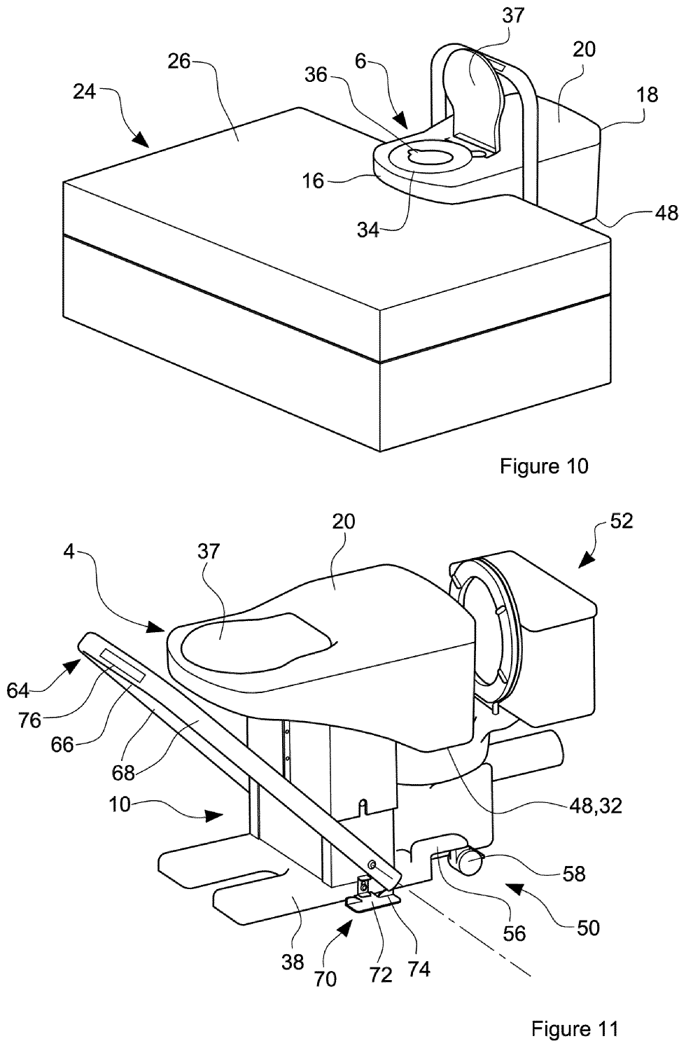

Referring to FIGS. 8 to 12, a toilet system 2 is shown according to a second embodiment. The toilet system 2 is generally similar to the system of FIGS. 1-7, except where indicated otherwise.

In the second embodiment, the lower surface 22 has a concave profile between the first end 16 and the base 48 (i.e. when viewed along the depth direction D), rather than a straight profile. The curved profile helps the first end 16 to be shallower than that of the first embodiment.

The system 2 of the second embodiment further includes a handle 64 which is usable to help manoeuvre the system 2 between locations as shown in FIGS. 9 to 11. The handle 64 extends in a U-shape around the body 10, the U-shape defining a central portion 66 and two parallel outer elongate portions or arms 68 which are interconnected by the central portion. The arms 68 are rotatably mounted to respective opposite sides of the first portion 40 of the body 10 by a respective pair of pins or other pivotal connections. The second portion 42 of the body 10 includes respective cut-out portions or slots at its lower edge to accommodate the pins (see FIGS. 9 and 11) when the body is in its lowermost position relative to the base. This complementary arrangement allows the second portion 42 to slide over the first portion 40 without being obstructed by the pins.

In variant embodiments, which are not illustrated, the handle may be movably attached to the body by other suitable means, and/or may be movably attached to a different portion of the system (e.g. the head). In variant embodiments, which are not illustrated, the handle may be fixed rather than moveable. In some embodiments, the handle 64 may be removable from the body or other part of the system, to allow it to be completely removed if required.

The handle 64 is rotatable about an axis A, between a front position (FIG. 11), an upright position (FIG. 8), and a rear position (FIG. 9). The front and rear positions are particularly useful to permit a carer to push the toilet system 2 between different locations, e.g. from a patient support to a waste disposal location (e.g. a conventional toilet).

The foot 38 includes two retaining members 70 to securely retain the handle 64 in the front, rear, and upright positions. Each retaining member 70 comprises a generally flat plate whose inwardly directed edge (proximal the body 10) is folded upwardly at its front and back regions to define respective retaining projections extending upwardly from the plate. Each retaining member thus includes a flat central portion 72 and a pair of retaining projections 74. Each retaining projection presents an angled edge towards the axis A. The handle 64 is rotatable to selectively bear against the central portion 72 and each retaining projection 74 of the retaining members 70. When the handle 64 is positioned such that the lowermost edge of its arms 68 abut the flat portion 72, the flat portion 72 serves to resist movement of the handle either forward or backwards, thereby maintaining the handle 64 in the upright position (perpendicular to the foot 38). However, when sufficient force is applied to the handle 64, the handle may be rotated from its upright position such that the lowermost ends of its arms 68 move out of abutment with the central portion 72, and subsequently into abutment with either the front or the rear retaining projections 74, the retaining projections then serving to maintain the handle 64 in respective rear and front positions at an angle to the foot 38.

Because the retaining members 70 are located at the bottom of the foot 38 (proximal the ground), the force exerted by the handle 64 against each retaining member 70 may help lock the system 2 in position relative to the ground, by bearing against the ground. The handle and retaining members 70 may therefore be thought of as providing a lever for the toilet system.

In variant embodiments, which are not illustrated, the retaining members may be configured differently, e.g. as a latch to engage the handle, and may be located on different areas of the system (e.g. the body or head).

The toilet system 2 includes a control device or control panel 76 to receive a user command for operating the system 2. For example, the control panel may include buttons or a touchscreen display, and may be used to control a flush, bidet, air dryer, the position of the head, and/or lateral movement of the system.

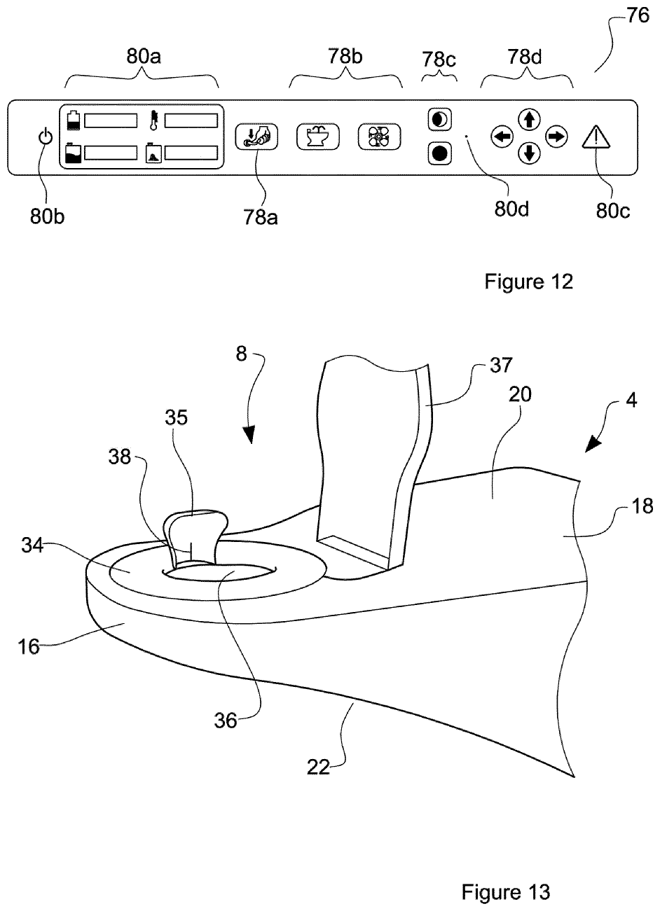

Referring to FIG. 12, the control panel 76 includes control buttons 78a-78c to receive a user command to operate the toilet system 2. The control buttons include a flush control button 78a , hygiene control buttons 78b , outlet control buttons 78c , and position control buttons 78d.

The flush control button 78a is usable to operate the flushing system 60.

The hygiene control buttons 78b are usable to clean the user. The hygiene control buttons 78b include a bidet control button for operating a bidet system, and an air dryer control button for operating a drying system. The bidet system and drying system are each activated for a predetermined time duration after their respective control buttons are selected. The time duration may be set by a user preference which is stored in the toilet system's electrical circuitry.

The outlet control buttons 78c are operable to actuate the valve in the outlet between an open and closed position. The outlet control buttons 78c may also be considered to represent part of an actuation mechanism, as described in the first embodiment. In FIG. 12, the outlet control buttons 78c include a first control button for opening the outlet valve, and a second control button for closing the outlet valve.

The position control buttons 78d are usable to adjust the lateral position and/or height of the head 4. The position control buttons 78d include a set of up/down and left/right arrow keys, although a variety of other configurations may be suitable (e.g. a joystick).

In variant embodiments, which are not illustrated, the control panel may include different controls and/or may omit any of the controls described herein.

The control panel 76 further includes status indicators 80a-80d to display information about the status of the toilet system 2. The status indicators include variable indicators 80a to provide graphical indications of the toilet system's status. The variable indicators 80a include a battery indicator (to indicate the system's remaining battery power), a temperature indicator (to indicate the temperature of water in the toilet system, i.e. of bidet water in the bidet system), a water level indicator (to indicate remaining water reserves in the flushing system 60 for flushing the pan 36 and/or in the bidet system for cleaning the user), and a waste indicator (to indicate the quantity of waste stored in the waste-receiving reservoir 62). Based on the indications provided, a carer or user may then take appropriate action to operate the system 2, e.g. by refilling the system's water reserves if the water level bar graph is too low, or e.g. by emptying the reservoir 62 if the waste level is too high. In variant embodiments, which are not illustrated, the variable indicators may be configured differently, e.g. as a numerical value or table of values.

The control panel 76 further includes a power indicator 80b to illuminate when the system 2 is connected to a mains supply for charging. Also provided is a warning light 80c to illuminate when the electrical circuitry detects one or more alert conditions associated with the system 2. For example, the warning light 80c may illuminate when a variable indicator 80a indicates a value outside a pre-determined acceptable range, e.g. if the battery level is less than 15%. In embodiments having a patient support position detection system, the warning light may illuminate when the patient support position detection system determines that the head 4 is not in the engaged position. The control panel 76 may further include a speaker for producing an audio alert associated with the alert condition.

An outlet valve indicator 80d is configured to illuminate when the outlet valve is in an open position, and to only turn off when the outlet valve is fully closed.

In variant embodiments, which are not illustrated, the status indicators may be separate from the control panel. In variant embodiments, which are not illustrated, the system may include different status indicators and/or may omit any of the status indicators described herein.

The control panel 76 is located on an outer face of the central portion 66 of the handle 64. In this configuration, the control panel 76 may face toward a carer operating the system 2 when the handle 62 is in the front or rear positions; and may face towards a user of the bedpan while the handle 62 is in the upright position.

In variant embodiments, the control panel may be located on other portions of the handle, or on other surfaces of the system (e.g. the head).

In variant embodiments, the control panel may be remotely located, e.g. as a remote control. The remote control may be usable to operate a drive system to move the system to the engagement position, for example as discussed in the first embodiment.

Referring to FIG. 13, the seat bed pan assembly 8 of the second embodiment further includes a lid 37 which is hinged to cover the seat 34. A detachable splash guard 35 may be slotted onto to the seat 34. The splash guard 35 has a generally hollow and concave shape, similar to a large sports groin protector. An elongate groove 38 is provided at the base of the splash guard 35, to facilitate insertion therethrough of a catheter and to help direct the catheter toward the pan 36. In variant embodiments, which are not illustrated, the groove is located nearer the top of the splash guard (i.e. further from the pan when in use), and/or is angled downwards to reduce the likelihood of liquid entering the groove. In variant embodiments, which are not illustrated, the splash guard may omit the groove, e.g. for a female version of the splash guard.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

LIST OF REFERENCES

```
2 Mobile toilet system
    4 Head
        16 First end
        18 Second end
            48 Base
        20 Upper surface
        22 Lower surface
        46 Handles
    6 Waste material capturing system
        8 Seat bed pan assembly
            34 Seat
            35 Splash guard
                38 Groove
            36 Pan
            37 Lid
        30 Reservoir
        32 Outlet
        60 Flushing system
            62 Reservoir
    10 Body
        12 Proximal end
            38 Foot
                50 Docking member
                      54 Channel
                            56 Extensions
                58 Supporting wheels
            40 First portion
        14 Distal end
            42 Second portion
    64 Handle
        66 Central portion
        68 Outer portions/arms
    70 Retaining member
        72 Flat central portion
        74 Retaining projections
    76 Control panel
        78a-78c Control buttons
        80a-80d Status indicators
24 Patient support
        26 Support surface
52 Conventional toilet
```

1. A mobile toilet system comprising:
a head and a body,
the body extending longitudinally from a proximal end to a distal end, the proximal end adapted for engagement with the ground and the distal end adapted for support of said head,
the head extending laterally from a first end to a second end, and connected to the distal end of the body, the head comprising an upper surface and a lower surface, the upper surface comprising a seat bedpan assembly, wherein the lower surface is inclined to the lateral direction to taper with a narrowing section from the second end to the first end,
wherein the head is configured to be movable in the lateral direction between a disengaged position and an engaged position with said lower surface maintained with said incline to the lateral direction,
wherein in the engaged position a seat of the bed pan assembly is arrangeable over a support surface of a patient support and in the disengaged position the head is arrangable distal the patient support,
the mobile toilet system further comprising a reservoir fluidly connected to the bedpan assembly, an outlet of the reservoir arranged at the second end of the head, at or in operative proximity to a base thereof.

2. The mobile toilet system of claim 1, wherein the head is movable in the lateral direction between the disengaged position and the engaged positions with the upper surface aligned to the lateral direction.

3. The mobile toilet system of claim 1, wherein to move the head between the disengaged position and the engaged position:
the proximal end of the body is adapted to slide along the ground, and/or;
the head is slideably connected to the body.

4. The mobile toilet system of claim 1, wherein an angle of inclination between the upper surface and lower surface is 10° to 30°.

5. The mobile toilet system of claim 1, wherein the base of the second end is generally planar and is aligned to the upper surface.

6. The mobile toilet system of claim 1, wherein the head and/or body are adapted for user actuation between the disengaged position and the engaged position.

7. The mobile toilet system of claim 1, wherein the head is mechanically actuated between the disengaged position and the engaged position by an automated drive system.

8. The mobile toilet system of claim 7, comprising a patient support position detection system operable to determine a position of the patient support, the automated drive system to drive the head to a position based on the determined position of the patient support.

9. The mobile toilet system of claim 7, comprising electrical circuitry to store a user preference and to control the automated drive system to drive the head to a position based on the user preference.

10. The mobile toilet system of claim 1, wherein the head is slideably connected to the body to slide along the longitudinal axis to adjust a height of the head.

11. The mobile toilet system of claim 1, wherein the proximal end of the body comprises a docking member adapted to engage with a conventional toilet, the docking member arranged to locate said conventional toilet for receiving fluid from the reservoir via the outlet.

12. The mobile toilet system of claim 11, wherein the docking member includes an adjustable channel for engagement with the conventional toilet.

13. The mobile toilet system of claim 1, wherein the lower surface tapers with a concave profile.

14. The mobile toilet system of claim 1, further comprising a handle which is rotatable about the head.

15. The mobile toilet system of claim 14, further comprising a retaining member to maintain the handle in a position with respect to the head.

16. A method of engaging a mobile toilet system with a patient support surface of a patient support, the method comprising:
moving a first end of a head of the toilet system over said patient support surface, wherein a lower surface of the head arranged proximal the patient support surface tapers from a second end of the head to the first end to effect progressive compression of the patient support.

17. The method of claim 16, wherein the system further comprises an outlet arranged at the second end of the head, the method further comprising:
moving the second end of the head over a conventional toilet; and
dispensing waste through the outlet into the conventional toilet.
